(19) United States
(12) Patent Application Publication
(10) Pub. No.: US 2006/0209311 A1
(43) Pub. Date: Sep. 21, 2006

(54) Image processing apparatus and image processing method

(75) Inventors: Shunichi Megawa, Tagata-gun (JP); Takahiro Fuchigami, Yokosuka-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/079,466

(22) Filed: Mar. 15, 2005

(51) Int. Cl. G06F 3/12

(52) U.S. Cl. 358/1.1

(57) ABSTRACT

An image processing apparatus includes an image inputting unit configured to input image data of an original image, an area specifying unit configured to specify a predetermined area in the input original image as a specified area, a partial image creating unit configured to create a partial image by extracting an image section corresponding to the specified area specified by the area specifying unit, and a miniature image creating unit configured to reduce the partial image and to create a miniature image. According to the present invention, a thumbnail appropriately indicating the content and the feature of an original image are readily and quickly created even if the original image includes a complex image section.

### BACKGROUND OF THE INVENTION

1. Field of the Invention

The present invention relates to an image processing apparatus and an image processing method. In particular, the present invention relates to an image processing apparatus and an image processing method capable of creating a thumbnail.

2. Description of the Related Art

Thumbnails (miniature images) are often used when desired image files are retrieved from hard disks contained in personal computers or from web pages.

Thumbnails are reduced-size reproductions of original images. Therefore, a user can view the content of an image file using a thumbnail of the image file more quickly than viewing the content by directly opening the original image file.

However, since thumbnails are produced by reducing original images, if an original image includes a complex image section, it is difficult for a user to determine whether the original image file is a desired file by viewing the content using only a thumbnail. As a result, the user must open the original image file to check the content, so that the operation is complicated and retrieving the desired file requires a long time.

Japanese Unexamined Patent Application Publication No. 2004-173085 discloses a technique for generating a margin in a thumbnail and writing a selected information item as an image section on the margin.

This technique realizes a thumbnail with much information, compared to a thumbnail produced by simply reducing an original image.

However, the amount of information attachable in the margin is limited. In addition, information appropriately indicating the content or the feature of the original image cannot be attached in many cases. As a result, it is difficult to determine whether an original image file is a desired file by viewing only a thumbnail with information attached in a margin.

Therefore, there is a demand for providing an image processing apparatus and an image processing method that is capable of readily and quickly creating a thumbnail appropriately indicating the content and the feature of an original image even if the original image includes a complex image section.

### SUMMARY OF THE INVENTION

Accordingly, it is an object of the present invention to provide an image processing apparatus and an image processing method that is capable of readily and quickly creating a thumbnail appropriately indicating the content and the feature of an original image even if the original image includes a complex image section.

In a first aspect of the present invention, an image processing apparatus includes an image inputting unit configured to input image data of an original image, an area specifying unit configured to specify a predetermined area in the input original image as a specified area, a partial image creating unit configured to create a partial image by extracting an image section corresponding to the specified area specified by the area specifying unit, and a miniature image creating unit configured to reduce the partial image and to create a miniature image.

In a second aspect of the present invention, an image processing method includes an image data inputting step of inputting image data of an original image, an area specifying step of specifying a predetermined area in the input original image as a specified area, a partial image creating step of creating a partial image by extracting an image section corresponding to the specified area, and a miniature image creating step of reducing the partial image and of creating a miniature image.

### BRIEF DESCRIPTION OF THE DRAWINGS

FIG. 1 is a block diagram of an image processing apparatus according to a first embodiment of the present invention;

FIG. 2 shows an example of an area specifying unit of the image processing apparatus according to the first embodiment;

FIGS. 3A to 3C are illustrations for explanation of an example of a miniature image creating method in the image processing apparatus according to the first embodiment;

FIG. 4 is a block diagram of an image processing apparatus according to a second embodiment of the present invention;

FIGS. 5A to 5F are illustrations for explanation of a first example of a miniature image creating method in the image processing apparatus according to the second embodiment;

FIGS. 6A and 6B are illustrations for explanation of a second example of the miniature image creating method in the image processing apparatus according to the second embodiment;

FIG. 7 is a block diagram of an image processing apparatus according to a third embodiment;

FIGS. 8A and 8B are illustrations for explanation of an example of a layout creating method in the image processing apparatus according to the third embodiment;

FIG. 9 is a block diagram of a first example of a divided region selecting unit of the image processing apparatus according to the third embodiment;

FIG. 10 is a block diagram of a second example of the divided region selecting unit of the image processing apparatus according to the third embodiment;

FIG. 11 is a block diagram of a third example of the divided region selecting unit of the image processing apparatus according to the third embodiment;

FIG. 12 is an illustration for explanation of a method for selecting a specified area and changing the specified area in the image processing apparatus according to the third embodiment;

FIG. 13 is a block diagram of an image processing apparatus according to a fourth embodiment.

### DESCRIPTION OF THE PREFERRED EMBODIMENTS

The image processing apparatus and the image processing method according to the embodiments are described below with reference to the drawings.

### (1)First Embodiment

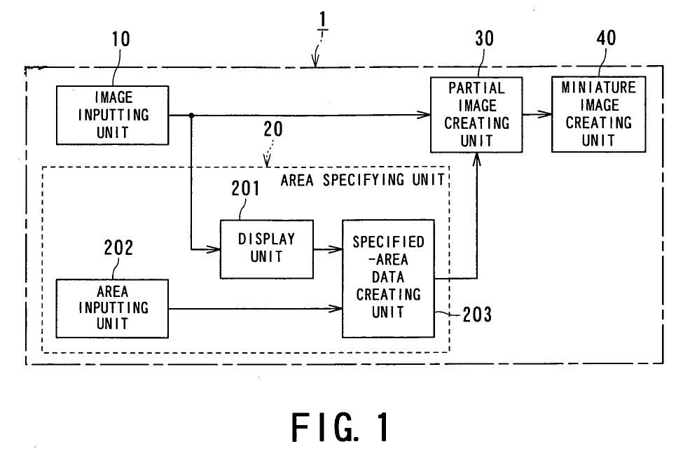

FIG. 1 shows an example of a configuration of an image processing apparatus 1 according to a first embodiment of the present invention.

The image processing apparatus 1 includes an image inputting unit 10 for inputting image data of an original image, an area specifying unit 20 for specifying a predetermined area in the input original image as a specified area, a partial image creating unit 30 for creating a partial image by extracting an image section corresponding to the specified area, and a miniature image creating unit 40 for reducing the partial image and creating a miniature image (thumbnail).

The area specifying unit 20 includes a display unit 201 for displaying an original image, an area inputting unit 202 for inputting a specified area by a user, and a specified-area data creating unit 203 for creating specified-area data from the input specified area.

The image inputting unit 10 may have various forms. For example, the image inputting unit 10 may be a form capable of receiving image data from an image data generating device, such as a scanner, a digital camera, or the like.

Alternatively, the image inputting unit 10 may be a form capable of receiving image data from an external storage medium, such as a compact disk read-only memory (CD-ROM), a digital versatile disk (DVD), or the like, or from a storage device, such as a hard disk contained in the image processing apparatus 1, or the like.

Alternatively, the image inputting unit 10 may be a communication interface of, for example, a local area network (LAN), the Internet, a telephone network, a leased line network, or the like. In this case, the network may be a wired one, a wireless one, or both.

The area specifying unit 20 sets a predetermined area as a specified area from input image data (original image) and creates data indicating the specified area. Setting a specified area may be performed by various techniques, such as a manual one, a semiautomatic one, an automatic one, or the like. In the image processing apparatus 1 according to the first embodiment, a specified area is set mainly by a manual technique.

In the first embodiment, the area specifying unit 20 has the structure including the display unit 201 and the area inputting unit 202. The area specifying unit 20 having such a structure may have various forms. For example, if the image processing apparatus 1 is a scanner or a multi-function peripheral (MFP), which handles multiple functions, for example, copying and printing, a control panel of the scanner or the MFP can function as the area specifying unit 20.

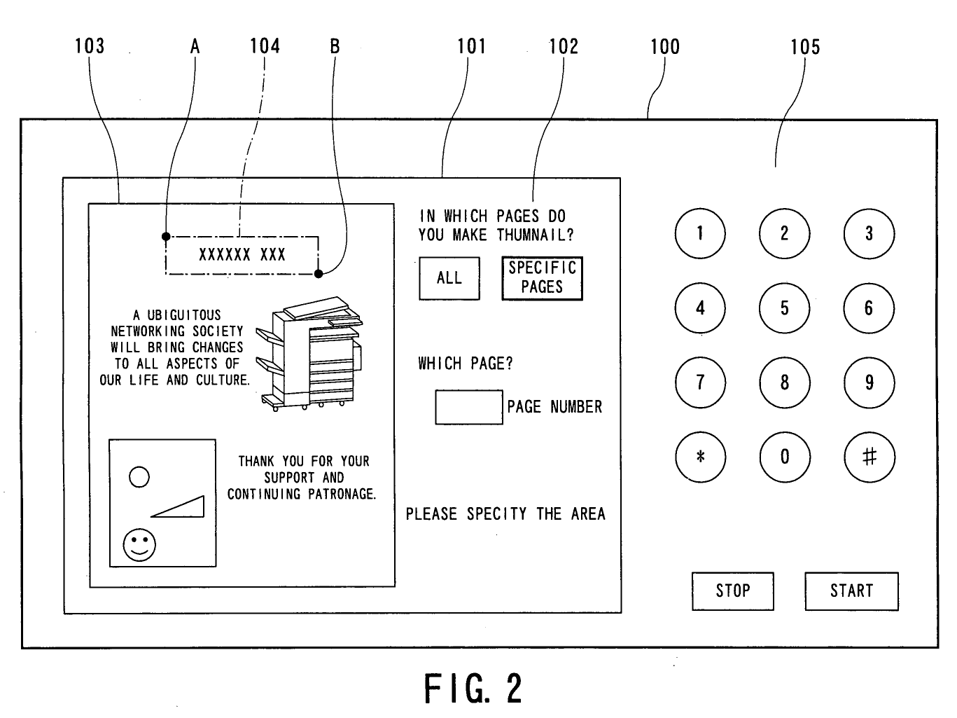

FIG. 2 shows an example of such a control panel of the MFP or the scanner. Operating keys 105 and a liquid crystal display (LCD) 101 serving as the display unit 201 are arranged on a control panel 100. The LCD 101 includes a touch panel 102 appearing thereon. A user can input various data and performs various settings using the touch panel 102.

When a user presses points A and B shown in FIG. 2 by his or her finger or by means of a pointer on the touch panel 102 on the LCD 101 displaying an original image 103, a rectangular region 104 whose diagonal corners are the points A and B is set as a specified area 104.

Since this way of specifying an area is merely one example, other ways may be used. For example, if the image processing apparatus 1 has a pointing device, such as a mouse or a touch pad, a specified area can be set by the use of the pointing device and an appropriate marker appearing on the display unit 201.

The partial image creating unit 30 extracts an image section corresponding to the specified area 104 specified by the area specifying unit 20 from the original image and creates a partial image.

The miniature image creating unit 40 reduces the partial image created by the partial image creating unit 30 and create a miniature image.

The partial image creating unit 30 and the miniature image creating unit 40 may be realized by hardware using a logic circuit or by executing a software program by a CPU (computer) or by a combination of hardware and software.

An example of the operation of the image processing apparatus 1 having the structure described above is described below.

The image inputting unit 10 receives the original image 103 from, for example, a hard disk (not shown) contained in the image processing apparatus 1. The original image 103 may be a one page image or an image containing multiple pages.

The original image 103 inputted from the image inputting unit 10 is displayed on the display unit 201 of the area specifying unit 20, for example, on the LCD 101 on the control panel 100 shown in FIG. 2.

Next, a user presses the points A and B using the area inputting unit 202, for example, the touch panel 102, to set the rectangular region 104 whose diagonal corners are the points A and B as the specified area 104.

If the original image 103 contains multiple pages, the specified area can be set in every page when “all” is selected, and can be set in only each specified page when “specific pages” is selected, as shown in FIG. 2.

In the specified-area data creating unit 203, the set specified area 104 is represented as specified area data expressed as, for example, the coordinates in the original image 103.

The partial image creating unit 30 extracts an image section corresponding to the specified area 104 from the original image 103 and creates a partial image 107.

The miniature image creating unit 40 creates a miniature image (thumbnail) with a predetermined size so that the created partial image 107 has high visibility, a high image quality, and an accurate form.

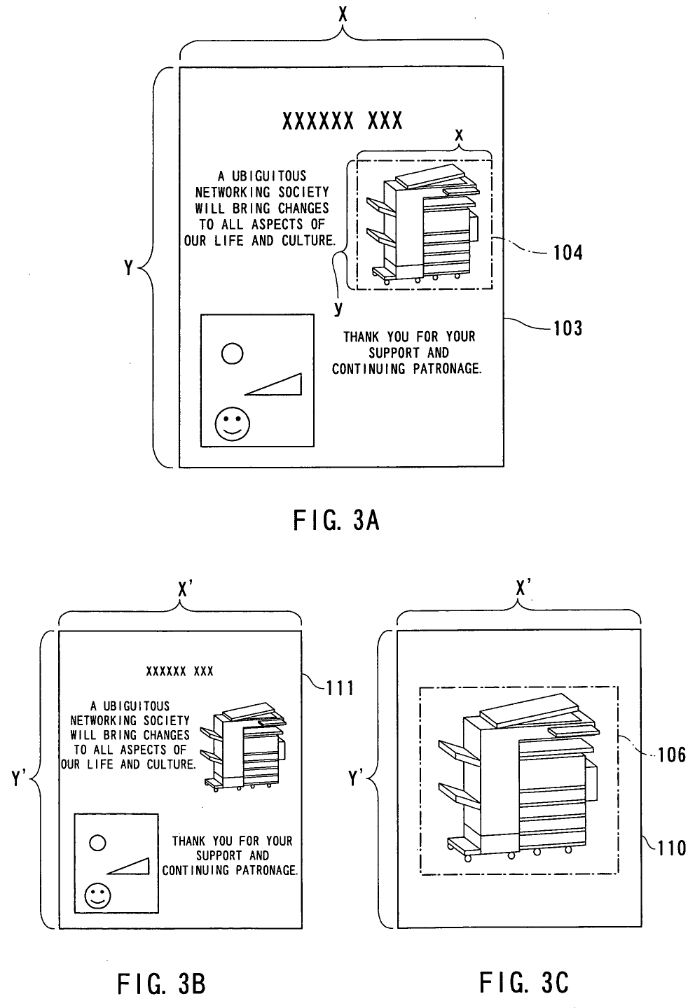

An example of a method for creating the miniature image 106 is described below with reference to FIGS. 3A to 3C. FIG. 3A shows an example of the original image 103 input from the image inputting unit 10. In FIG. 3A, the portion surrounded by dash-dot lines represents the specified area 104 specified by the area specifying unit 20.

The horizontal axis is the x-axis, and the vertical axis is the y-axis in the original image 103. The horizontal length of the original image 103 is represented as X, and the vertical length of the original image 103 is represented as Y. The horizontal length of the specified area 104 in the original image 103 is represented as x, and the vertical length of the specified area 104 in the original image 103 is represented as y.

FIG. 3B shows a miniature image (thumbnail) 111 created by a conventional technique. The horizontal length of the miniature image 111 is represented as “X′”, and the vertical length thereof is represented by “Y′”.

In a conventional method for creating the miniature image 111, the entire area of the original image 103 is reduced to the miniature image 111 by multiplying the horizontal length by (X/X′) and by multiplying the vertical length by (Y/Y′). Therefore, even when an important area for identifying the original image 103 is determined to exist in the original image 103, the original image 103 is uniformly reduced.

When an aspect ratio of the original image 103 differs from an aspect ratio of the miniature image 111 (i.e., (X/Y)≠(X′/Y′)), the miniature image 111 is distorted.

Therefore, it may become difficult to identify the original image 103 only by viewing the miniature image 111.

In contrast to this, a method for creating a miniature image 110 according to the first embodiment extracts the specified area 104 from the original image 103 and crates the miniature image 110 using only an extracted partial image 106, as shown in FIG. 3C.

More specifically, the miniature image 110 is created by reducing the size of the specified area 104 by multiplying both the horizontal and vertical lengths by a single reduction ratio min(X/X′, Y/Y′). The min(a, b) means the numerical minimum of a and b.

If min(X/X′, Y/Y′)<1, the specified area is reduced. If min(X/X′, Y/Y′)>1, the specified area is enlarged.

In the case where enlargement is performed, since an enlarged image is prone to being degraded more largely than a reduced image, the miniature image 110 may be created by maintaining the size of the specified area 104.

Reducing the size of the specified area 104 with a single reduction ratio, min(X/X′, Y/Y′), with respect to the horizontal and vertical lengths allows reduction of the specified area 104 without changing the aspect ratio of the specified area 104 such that the reduced specified area has a maximum size in the miniature image 110. As a result, the miniature image 110 can be created so as to have high visibility, a high image quality, and have no distortion with respect to the horizontal and vertical directions.

In this embodiment, when the aspect ratio of the specified area 104 differs from the aspect ratio of the miniature image 110, a margin may be present in the miniature image 110. In this case, various kinds of information can be described in the margin of the miniature image 110. Examples of such information include the date of inputting an image, the type of the image inputting unit 10 (e.g., a scanner), and a page number.

### (2)Second Embodiment

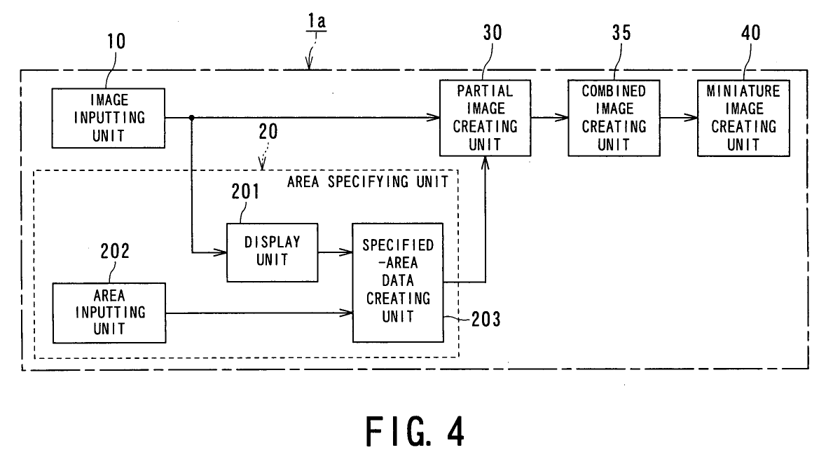

FIG. 4 shows an image processing apparatus 1a according to a second embodiment. The image processing apparatus 1a according to the second embodiment has the structure, in which a combined-image creating unit 35 is added between the partial image creating unit 30 and the miniature image creating unit 40 in the image processing apparatus 1 according to the first embodiment.

In the second embodiment, when a plurality of specified areas 104 are set in the single original image 103 or when the plurality of specified areas 104 are set in the plurality of original images 103, a plurality of partial images 106 extracted by the partial image creating unit 30 are combined to create a combined partial image 107. The combined partial image 107 is reduced by the miniature image creating unit 40 to crate the miniature image 110.

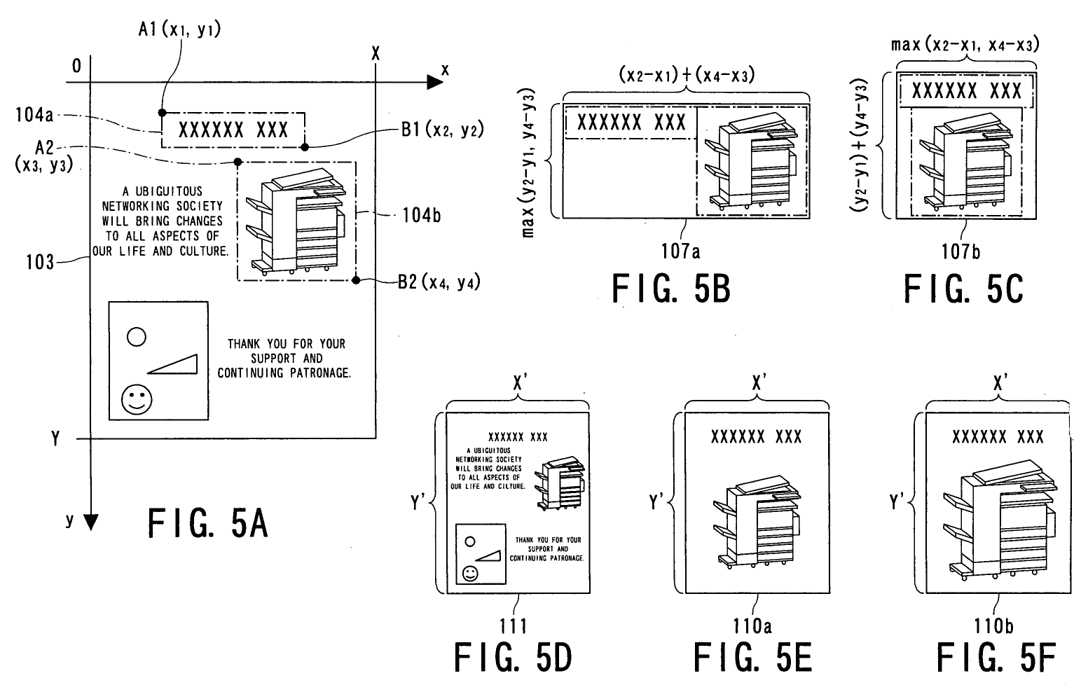

An example of a method for creating the combined partial image 107 by combining the plurality of partial images 106 is described below with reference to FIGS. 5A to 5F.

As shown in FIG. 5A, in a coordinate system where the origin point (0, 0) is at the upper-left corner of the original image 103, the coordinates of the upper-left corner A1 of a first specified area 104a is represented as (x₁, y₁), and the coordinates of the lower-right corner B1 of the first specified area 104a is represented as (x₂, y₂), where x₁<x₂ and y₁<y₂.

The coordinates of the upper-left corner A2 of a second specified area 104b is represented as (x₃, y₃), and the coordinates of the lower-right corner B2 of the second specified area 104b is represented as (x₄, y₄), where x₃<x₄ and y₃<y₄.

Creating a miniature image 110a having a width of X′ and a height of Y′ is described below. In this embodiment, only an area determined by a user to be important is extracted in order to minimize the amount of reduction in image size.

The arrangement of the first specified area 104a and the second specified area 104b is first determined. In order to determine whether to arrange the two specified areas 104a and 104b horizontally or vertically, an intermediate image 107a, where the two specified areas 104a and 104b are arranged horizontally, shown in FIG. 5B, and an intermediate image 107b, where the two specified areas 104a and 104b are arranged vertically, shown in FIG. 5C, are created. Then, one of the intermediate images 107a and 107b, which has an aspect ratio nearer to the aspect ratio of the miniature image 110a, is selected.

As shown in FIG. 5B, where the two specified areas 104a and 104b are arranged horizontally, the width of the intermediate image 107a is represented by {(x₂−x₁)+(x₄−x₃)}, and the height thereof is represented by max{(y₂−y₁), (y₄−y₃)}.

As shown in FIG. 5C, where the two specified areas 104a and 104b are arranged vertically, the width of the intermediate image 107b is represented by max{(x₂−x₁), (x₄−x₃), and the height thereof is represented by {(y₂−y₁)+(y₄−y₃)}.

One of the intermediate images 107a and 107b, which has an aspect ratio (width-to-height) nearer to the aspect ratio of the miniature image 110a, is selected. In this case, the arrangement in which the two specified areas are arranged vertically is selected.

If more than two specified areas are set, two partial images corresponding to two specified areas are combined by the method described above to create a combined partial image 107, and the combined partial image 107 and a third partial image extracted as the specified area 104 are combined by the same method to create a new combined partial image. This process is repeated, so that the intermediate image 107, in which all of more than two partial images are arranged, is created.

Therefore, even when the plurality of specified areas 104 are set, reducing the combined partial image (intermediate image) 107 created by this way by the same reduction method and arrangement method as the case where the single specified area is set allows a miniature image 110a (shown in FIG. 5E), in which only the specified areas 104 are arranged, to be created.

As shown in FIG. 5D, a miniature image 111 created by a conventional method is realized by uniformly reducing the entire area of the original image 103. As a result, when the original image 103 includes a complex image section, the visibility of the miniature image 111 is degraded, and thus, viewing only the miniature image 111 becomes difficult.

In contrast to this, a reduction method according to this embodiment creates the miniature image 110a using only the specified area 104 appropriately indicating the feature of the original image 103. Therefore, the miniature image 110a realizing readily viewing can be created.

The combined partial image 107b (107a) is realized by extracting the specified areas 104a and 104b so as to use the same reduction ratio or so as to have the same size. However, the importance of the specified areas may vary depending on the type of the original image 103. For example, as shown in FIG. 5A, if a user determines that the specified area 104b indicating “photograph” is more important than the specified area 104a indicating “title”, making the “photograph” area slightly larger than “title” area by assigning priorities, i.e., preferentially making the important area larger, creating the combined partial image 107, and creating the miniature image 110b shown in FIG. 5F using the combined partial image 107 may be performed. According to this embodiment, the visibility for the most important specified area 104 among the plurality of specified areas selected by a user can be improved, so that searching images can be readily performed in a short time.

If the plurality of original images 103 are input by means of an automatic document feeder (ADF), the plurality of specified areas 104 may be set in the plurality of original images 103, and the combined partial image 107 may be created in accordance with the plurality of specified areas 104.

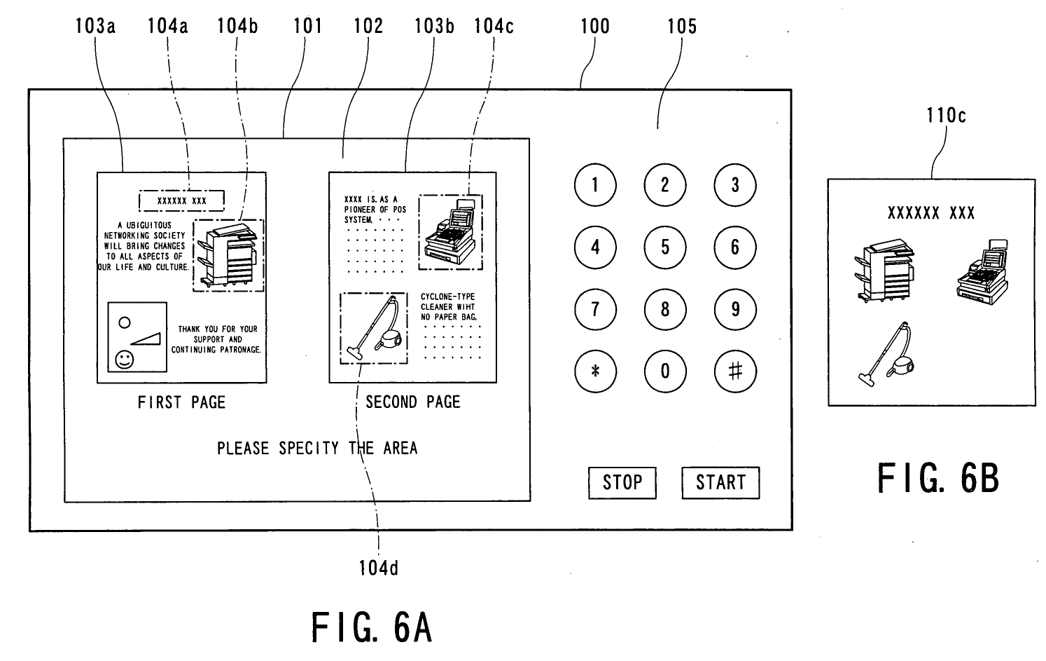

FIGS. 6A and 6B show an example of the area specifying unit 20 when important areas are selected from all pages in an image file containing a plurality of pages. In FIG. 6A, four specified areas 104a, 104b, 104c, and 104d are selected from an original image 103a of the first page and an original image 103b of the second page.

The four specified areas are combined by the combined-image creating unit 35 and then reduced to create a miniature image 110c shown in FIG. 6B.

In the embodiment in which the miniature image 110c is created from an image file containing a plurality of original images 103, the characteristic and important specified areas 104 are combined into the single miniature image 110c. As a result, viewing and identifying the entire image file can be performed in a short time.

Therefore, since the plurality of specified areas 104 are combined into the single miniature image 110 with high visibility, the image processing apparatus 1a according to the second embodiment can achieve readily viewing, in addition to the advantageous effects of the first embodiment.

### (3)Third Embodiment

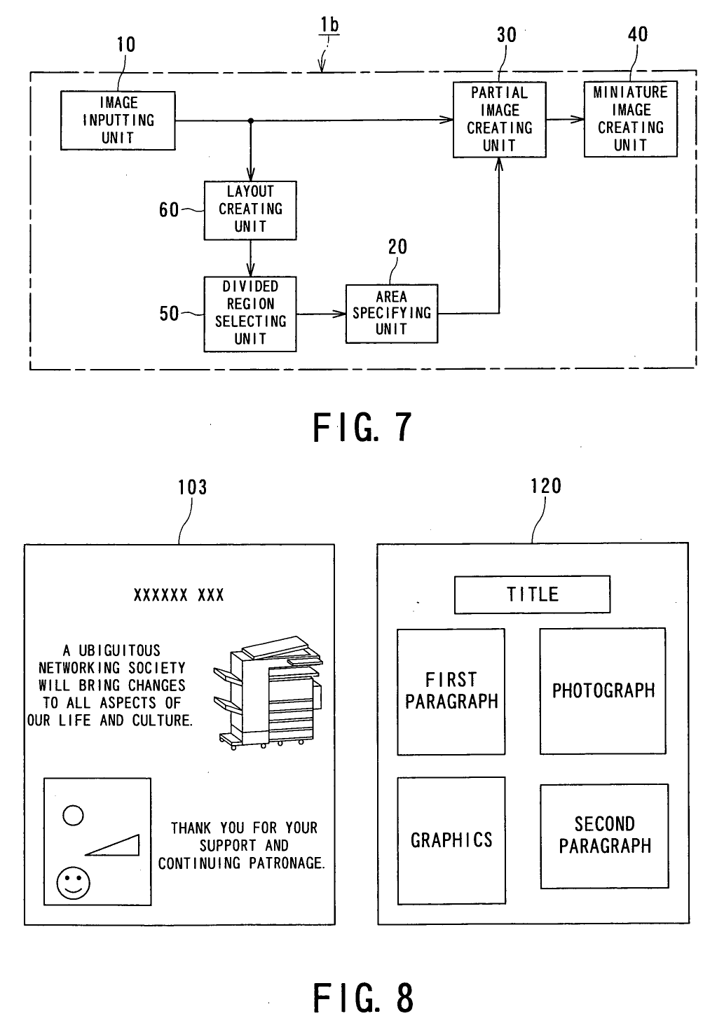

FIG. 7 shows an image processing apparatus 1b according to a third embodiment. The image processing apparatus 1b according to the third embodiment has the structure, in which a layout creating unit 60 and a divided-region selecting unit 50 are added to the image processing apparatus 1 according to the first embodiment.

In general, image data of an original image input from the image inputting unit 10 includes image data sections having one or more attributes. Examples of the attributes include “text”, “title”, “graphics”, “photograph”, “table”, and “graph”.

The layout creating unit 60 analyzes image data of an original image input from the image inputting unit 10, classifies the attributes in accordance with information contained in the image data of the original image and the like, and divides the original image into a plurality of regions individually corresponding to the classified attribute. The arrangement of the divided regions, which are divided individually corresponding to the attributes, can represent a layout of the original image.

Recognizing and classifying the attributes from the original image 103 can be realized by a known technique, for example, the technique disclosed in Japanese Unexamined Patent Application Publication No. 2003-087562.

FIGS. 8A and 8B are illustrations for explanation of a layout 120 (an arrangement of divided regions). FIG. 8A shows the original image 103, and FIG. 8B shows the layout 120 created from the original image 103. In FIGS. 8A and 8B, the original image 103 includes five attributes composed of “title”, “first paragraph”, “photograph”, “graphics”, and “second paragraph”. The layout creating unit 60 analyzes these attributes, divides the original image 103 into the five divided regions individually corresponding to the attributes, and creates the layout 120 by arranging the divided regions.

The divided-region selecting unit 50 selects one or more of the divided regions, which are divided by the layout creating unit 60. The divided regions selected by the divided-region selecting unit 50 are designated as specified areas in the area specifying unit 20 disposed in the next stage. In other words, the divided regions selected by the divided-region selecting unit 50 are identical with the specified areas.

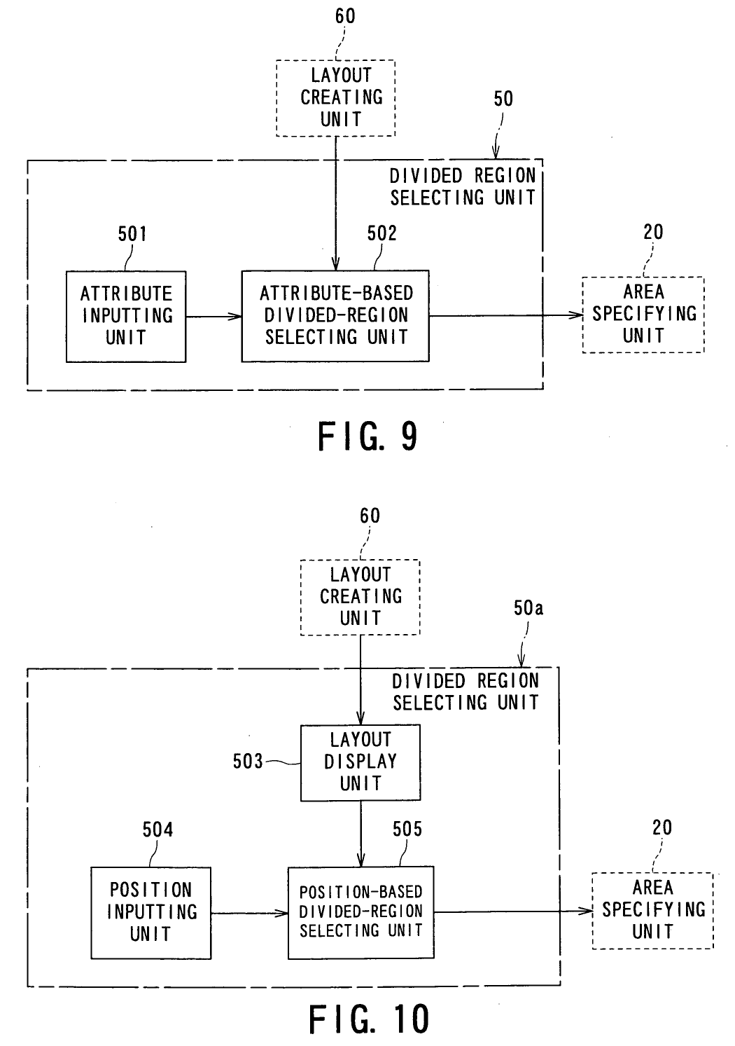

FIG. 9 shows a first example of the divided-region selecting unit 50. In this first example, the divided-region selecting unit 50 includes an attribute inputting unit 501 and an attribute-based divided-region selecting unit 502.

The attribute inputting unit 501 is used for inputting a specific attribute by a user. A user inputs a specific attribute, such as “title”, “graphics”, or “photograph”, in advance using, for example, the operating keys 105 and/or the touch panel 102 disposed on the control panel 100.

The attribute-based divided-region selecting unit 502 selects a divide region corresponding to the input attribute. In the first example, the attribute input by a user determines the specified area.

In the image processing apparatus 1b, the layout creating unit 60 divides the original image into the divided regions individually corresponding to the attributes, and the specified area 104 can be set by simply inputting a desired attribute by a user. Therefore, in addition to the advantageous effects of the first embodiment, the specified area 104 can be set in a simpler manner.

FIG. 10 shows a divided-region selecting unit 50a according to a second example of the divided-region selecting unit 50. In this second example, the divided-region selecting unit 50a includes a layout displaying unit 503, a position inputting unit 504, a position-based divided-region selecting unit 505.

The layout displaying unit 503 is composed of, for example, the LCD 101 disposed on the control panel 100. The position inputting unit 504 is used for specifying or inputting by a user a position of a divided region displayed on the layout displaying unit 503 to select the divided region as the specified area. The position inputting unit 504 may be realized by the operating keys 105 or by the touch panel 102 disposed on the LCD 101. For example, pressing the position of a desired divided region on the touch panel 102 allows the specified area to be readily and quickly set.

In the divided-region selecting unit 50a according to the second example, the specified area 104 can be selected using the touch panel 102 on the displayed layout. Therefore, the specified area 104 can be selected more readily and simply than the divided-region selecting unit 50 according to the first example.

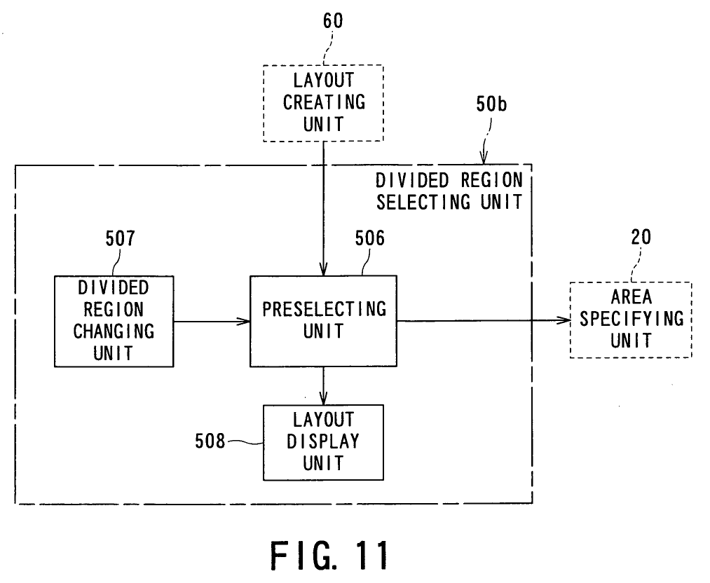

FIG. 11 shows a divided-region selecting unit 50b according to a third example of the divided-region selecting unit 50. In this third example, the divided-region selecting unit 50b includes a preselecting unit 506, a divided-region changing unit 507, a layout displaying unit 508.

The preselecting unit 506 automatically preselects a divided region in a predetermined manner. Examples of the predetermined manner include preferentially selecting a divided region positioned in the top of the original image and, when the original image contains an attribute of “title”, preferentially selecting a divided region whose attribute is “title”.

The selected divided region is displayed on the layout displaying unit 508 so as to be superimposed on the original image or the layout.

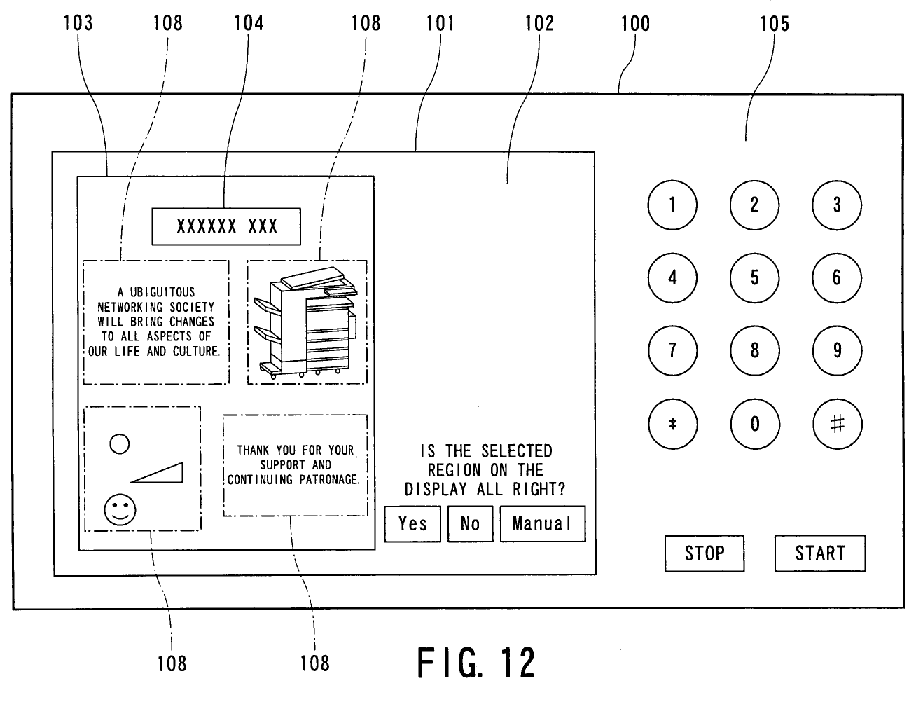

FIG. 12 shows an example of a state in which the divided regions created by the layout creating unit 60 is displayed on the layout displaying unit 508 so as to be superimposed on the original image. The layout displaying unit 508 is realized by, for example, the LCD 101 disposed on the control panel 100. The layout displaying unit 508 (the LCD 101) displays the selected divided region (the specified area 104) surround by solid lines, and the divided regions 108, which are not selected, enclosed by dash-dot lines.

In FIG. 12, the divided-region selecting unit 506 preferentially selects an attribute of “title”. A user can view the currently selected divided region (the specified area 104) using the layout displaying unit 508. To change the specified area 104 from the currently selected divided region to another divide region, pressing a desired divided region on the touch panel 102 (the divided region changing unit 507) disposed on the LCD 101 allows a new specified area 104 to be set.

In the divided-region selecting unit 50b according to the third example, the specified area 104 is automatically preselected, and a user can change the specified area using the touch panel 102 or the like if needed. Therefore, the specified area 104 can be selected more readily and simply.

When the divided region is selected in the divided-region selecting units 50, 50a, and 50b according to the first, second, and third examples, the selected divided region is set as the specified area 104 in the area specifying unit 20.

The specified area 104 specified by the area specifying unit 20 is extracted by the partial image creating unit 30 and is created as the partial image 106, as is the case with the first embodiment. Additionally, the partial image is reduced by the miniature image creating unit 40, and the miniature image 110 is created.

### (4)Fourth Embodiment

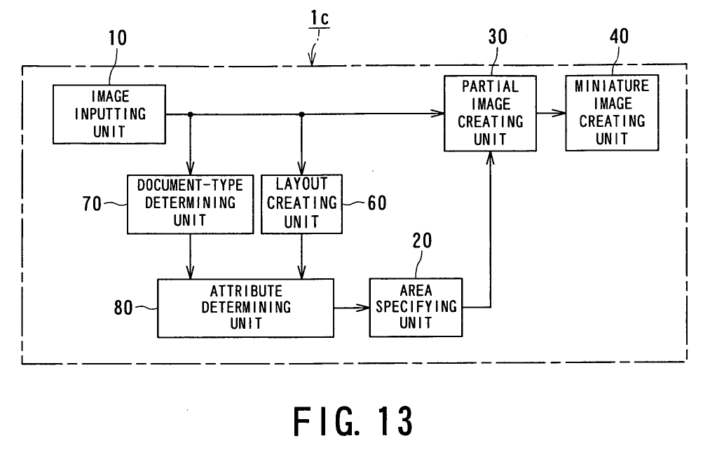

FIG. 13 shows an example of an image processing apparatus 1c according to a fourth embodiment. The image processing apparatus 1c according to the fourth embodiment includes the image inputting unit 10, the area specifying unit 20, the partial image creating unit 30, the miniature image creating unit 40, the layout creating unit 60, a document-type determining unit 70, and an attribute determining unit 80.

The document-type determining unit 70 determines a document type, such as a newspaper, a magazine, a paper, or the like, from input image data of an original image. Determining the document type of the original document may be performed by a known technique, for example, the technique disclosed in Japanese Unexamined Patent Application Publication No. 2004-193674.

The layout creating unit 60 analyzes the attributes of the original image, divides the original image into regions individually corresponding to the attributes, and creates a layout, as is the case with the third embodiment.

The attribute determining unit 80 determines an attribute to be preferentially selected in accordance with the document type. For example, when the document type determined by the document-type determining unit 70 is a technical paper, an attribute of “table” or “graph”, or both is preferentially selected. When the document type is a magazine, an attribute of “title” or “photograph”, or both is preferentially selected. When the document type is a newspaper, an attribute of “date” or “headline”, or both is preferentially selected.

Setting the divided region with the attribute determined by the attribute determining unit 80 as the specified area automatically selects the divided region with an important attribute as the specified area in accordance with the document type. Therefore, setting the specified area becomes simpler. Automatically set specified areas may be changed by a user as needed.

In the image processing apparatus 1c according to the fourth embodiment, the document type is automatically determined, and a divided area with an attribute that is determined to be important in accordance with the document type is automatically set as the specified area 104. Therefore, the miniature image can be created simply and quickly.

While the present invention has been described with reference to exemplary embodiments, it is to be understood that the invention is not limited to the disclosed embodiments. The invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. An image processing apparatus comprising:
an image inputting unit configured to input image data of an original image;
an area specifying unit configured to specify a predetermined area in the input original image as a specified area;
a partial image creating unit configured to create a partial image by extracting an image section corresponding to the specified area specified by the area specifying unit; and
a miniature image creating unit configured to reduce the partial image and to create a miniature image.

2. The image processing apparatus according to claim 1, wherein the miniature image creating unit creates the miniature image such that an aspect ratio of the created partial image remains unchanged even when the aspect ratio of the partial image differs from an aspect ratio of the miniature image.

3. The image processing apparatus according to claim 1, wherein the area specifying unit is configured to specify a plurality of predetermined areas as a plurality of specified areas, and
the partial image creating unit is configured to create a plurality of partial images by extracting image sections individually corresponding to the plurality of specified areas,
the image processing apparatus further comprising:
a combined image creating unit configured to create a combined image by densely arranging the plurality of partial images created,
wherein the miniature image creating unit creates the miniature image such that aspect ratios of the plurality of partial images created remain unchanged even when an aspect ratio of the combined image differs from an aspect ratio of the miniature image.

4. The image processing apparatus according to claim 3, wherein the combined image creating unit creates the combined image such that the aspect ratios of the created partial images individually remain unchanged and such that reduction ratios of the partial images are individually set.

5. The image processing apparatus according to claim 3, wherein the image inputting unit is configured to input image data of a plurality of original images, and
the area specifying unit is configured to specify a plurality of predetermined areas in the plurality of original images.

6. The image processing apparatus according to claim 1, further comprising:
a layout creating unit configured to analyze a plurality of attributes of the original image, to divide the original image into a plurality of regions individually corresponding to the attributes, and to create a layout of the original image by arranging the plurality of divided regions; and
a divided region selecting unit configured to select at least one divided region from the plurality of divided regions,
wherein the area selecting unit designates the selected divided region as the specified area.

7. The image processing apparatus according to claim 6, wherein the divided region selecting unit comprises an attribute inputting unit configured to input at least one of the plurality of attributes, and
the divided region selecting unit selects the divided region corresponding to the input attribute.

8. The image processing apparatus according to claim 6, wherein the divided region selecting unit comprises:
a layout displaying unit configured to display the created layout; and
a position inputting unit configured to input a position of the divided region,
wherein the divided region selecting unit selects the divided region by specifying the position of the divided region in the displayed layout.

9. The image processing apparatus according to claim 6, wherein the divided region selecting unit comprises:
a preselecting unit configured to preselect a predetermined divided region in the plurality of divided regions;
a layout displaying unit configured to display the created layout and to display the preselected divided region so as to be superimposed on the displayed layout and be readily recognizable; and
a region changing unit configured to be capable of changing the selection from the divided region to another divided region,
wherein the divided region selecting unit selects the preselected divided region or another divided region to which the selection is changed.

10. The image processing apparatus according to claim 1, further comprising:
a document type determining unit configured to determine a document type of the original image;
a layout creating unit configured to analyze a plurality of attributes of the original image, to divide the original image into a plurality of regions individually corresponding to the attributes, and to create a layout of the original image by arranging the plurality of divided regions; and
an attribute determining unit configured to determine an attribute to be preferentially selected from the plurality of attributes contained in the original image in accordance with the determined document type,
wherein the area specifying unit designates the divided region corresponding to the determined attribute as the specified area.

11. An image processing method comprising:
an image data inputting step of inputting image data of an original image;
an area specifying step of specifying a predetermined area in the input original image as a specified area;
a partial image creating step of creating a partial image by extracting an image section corresponding to the specified area; and
a miniature image creating step of reducing the partial image and of creating a miniature image.

12. The image processing method according to claim 11, wherein the miniature image creating step creates the miniature image such that an aspect ratio of the created partial image remains unchanged even when the aspect ratio of the partial image differs from an aspect ratio of the miniature image.

13. The image processing method according to claim 11, wherein the area specifying step specifies a plurality of predetermined areas as a plurality of specified areas, and
the partial image creating step creates a plurality of partial images by extracting image sections individually corresponding to the plurality of specified areas,
the image processing method further comprising:
a combined image creating step of creating a combined image by densely arranging the plurality of partial images created,
wherein the miniature image creating step creates the miniature image such that aspect ratios of the plurality of partial images created remain unchanged even when an aspect ratio of the combined image differs from an aspect ratio of the miniature image.

14. The image processing method according to claim 13, wherein the combined image creating step creates the combined image such that the aspect ratios of the created partial images individually remain unchanged and such that reduction ratios of the partial images are individually set.

15. The image processing method according to claim 13, wherein the image inputting step inputs image data of a plurality of original images, and
the area specifying step specifies a plurality of predetermined areas in the plurality of original images.

16. The image processing method according to claim 11, further comprising:
a layout creating step of analyzing a plurality of attributes of the original image, of dividing the original image into a plurality of regions individually corresponding to the attributes, and of creating a layout of the original image by arranging the plurality of divided regions; and
a divided region selecting step selects at least one divided region from the plurality of divided regions,
wherein the area selecting step designates the selected divided region as the specified area.

17. The image processing method according to claim 16, further comprising an attribute inputting step of inputting at least one of the plurality of the attributes,
wherein the divided region selecting step selects the divided region corresponding to the input attribute.

18. The image processing method according to claim 16, further comprising:
a layout displaying step of displaying the created layout; and
a position inputting step of inputting a position of the divided region,
wherein the divided region selecting step selects the divided region by specifying the position of the divided region in the displayed layout.

19. The image processing method according to claim 16, further comprising:
a preselecting step of preselecting a predetermined divided region in the plurality of divided regions;
a layout displaying step of displaying the created layout and of displaying the preselected divided region so as to be superimposed on the displayed layout and be readily recognizable; and
a region changing step of selectively changing the selection from the divided region to another divided region,
wherein the divided region selecting step selects the preselected divided region or another divided region to which the selection is changed.

20. The image processing method according to claim 11, further comprising:
a document type determining step of determining a document type of the original image;
a layout creating step of analyzing a plurality of attributes of the original image, of dividing the original image into a plurality of regions individually corresponding to the attributes, and of creating a layout of the original image by arranging the plurality of divided regions; and
an attribute determining step of determining an attribute to be preferentially selected from the plurality of attributes contained in the original image in accordance with the determined document type,
wherein the area specifying step designates the divided region corresponding to the determined attribute as the specified area.
